(19) United States
(12) Patent Application Publication
(10) Pub. No.: US 2010/0131920 A1
(43) Pub. Date: May 27, 2010

(54) PARAMETRIC EDA FUNCTION TOOL AND METHOD OF SIMPLIFYING EDA PROGRAMMING LANGUAGE

(75) Inventor: Farn Wang, Taipei (TW)

Correspondence Address: EDWARDS ANGELL PALMER & DODGE LLP, P.O. BOX 55874, BOSTON, MA, 02205, US

(73) Assignee: National Taiwan University, Taipei (TW)

(21) Appl. No.: 12/493,182

(22) Filed: Jun. 27, 2009

Related U.S. Application Data
(63) Continuation of application No. 12/362,089, filed on Jan. 29, 2009, now abandoned.

(30) Foreign Application Priority Data
Nov. 21, 2008 (TW) 097145048

(51) Int. Cl. G06F 9/44; G06F 9/45

(52) U.S. Cl. 717/106; 717/137; 717/126; 717/140; 717/114; 717/165

(57) ABSTRACT

The invention provides a parametric EDA function tool and a method of simplifying EDA programming language, characterized by using an EDA language unit to convert the programming language into a parametric EDA language mode having format strings and variable length arguments; using a function formation unit to form EDA function codes from the parametric EDA language; and using an executive file generator to compile the EDA function codes into an executive file to be executed by a verification device, thereby overcoming the drawbacks of having vast and inflexible EDA programming language that occupies large memory spaces and thus the increased costs for verification as encountered in prior techniques.

### BACKGROUND OF THE INVENTION

1. Field of the Invention

The present invention relates generally to parametric EDA function tools and methods of simplifying EDA programming language, and more particularly to an EDA function tool and a method of simplifying EDA programming language that convert the programming language into a parametric EDA language mode through format strings and variable length arguments.

2. Description of Related Art

At present, automatic symbolic verification technologies play a key role in the software engineering and chip design area. For example, designers often use EDA (Electronic Design Automation) software tools to speed up design processes. They can use EDA tools to simulate chip designs, build up product models or design operation processes prior to prototyping or production. Design using EDA software tools generally involves an iterative process through which problems or defects can be found and overcome.

The design concept of EDA software tools is to use data structures to express mathematic or logic conditions. In recent years, a large number of libraries have been developed. However, during the use of these libraries, if a condition needs to be built up according to an execution state of a program, a complicated conditional expression needs to be established from the most basic logic atom level by induction, thereby leading to vast programming language that occupies large memory spaces and consumes a lot of development time, and leads to an increased verification cost of EDA models.

Therefore, that is a need to provide a parametric EDA function tool and a method of simplifying EDA programming language so as to simplify the content of EDA programming language, thereby decreasing the verification cost of EDA models.

### SUMMARY OF THE INVENTION

According to the above drawbacks, the present invention is to provide a parametric EDA function tool and a method of simplifying EDA programming language so as to simplify the content of EDA programming language and thereby reduce the verification cost of EDA models.

The present invention provides a parametric EDA function tool and a method of simplifying EDA programming language. The parametric EDA function tool comprises: an EDA function code generator for converting the programming language into EDA function codes; and an executive file generator for compiling the EDA function codes into an executive file to be executed by a verification device, wherein the EDA function code generator comprises: an EDA language unit for converting the programming language into a parametric EDA language mode having format strings and variable length arguments; and a function formation unit for forming the EDA function codes from the parametric EDA language.

The method of simplifying EDA programming language of the present invention comprises the following steps: (1) converting the programming language into a parametric EDA language mode having format strings and variable length arguments; (2) forming EDA function codes from the parametric EDA language; and (3) compiling the EDA function codes into an executive file.

In a preferred embodiment, step (1) further comprises: (1-1) converting the programming language into at least a conditional format string; (1-2) establishing a positional parameter and a variable length argument corresponding to the conditional format string; and (1-3) substituting the positional parameter and variable length argument into the conditional format string so as to form the parametric EDA language mode.

In another preferred embodiment, the method of simplifying EDA programming language further comprises step (4) of loading the executive file into a memory of a verification device and executing the executive file.

Compared with the prior art, the present invention converts the programming language into a parametric EDA language mode having format strings and variable length arguments so as to simplify the programming language, thereby saving memory spaces and reducing the development time, and reducing the cost for building up and verifying EDA models.

### BRIEF DESCRIPTION OF DRAWINGS

FIG. 1 is a diagram showing a parametric function tool according to the present invention;

FIG. 2 is an application diagram of the parametric function tool according to a preferred embodiment of the present invention;

FIG. 3 is a flow diagram showing a method of simplifying EDA programming language according to the present invention; and

FIG. 4 is a flow diagram showing a method of simplifying EDA programming language according to a preferred embodiment of the present invention.

### DETAILED DESCRIPTION OF PREFERRED EMBODIMENTS

The following illustrative embodiments are provided to illustrate the disclosure of the present invention, these and other advantages and effects can be apparent to those skilled in the art after reading the disclosure of this specification.

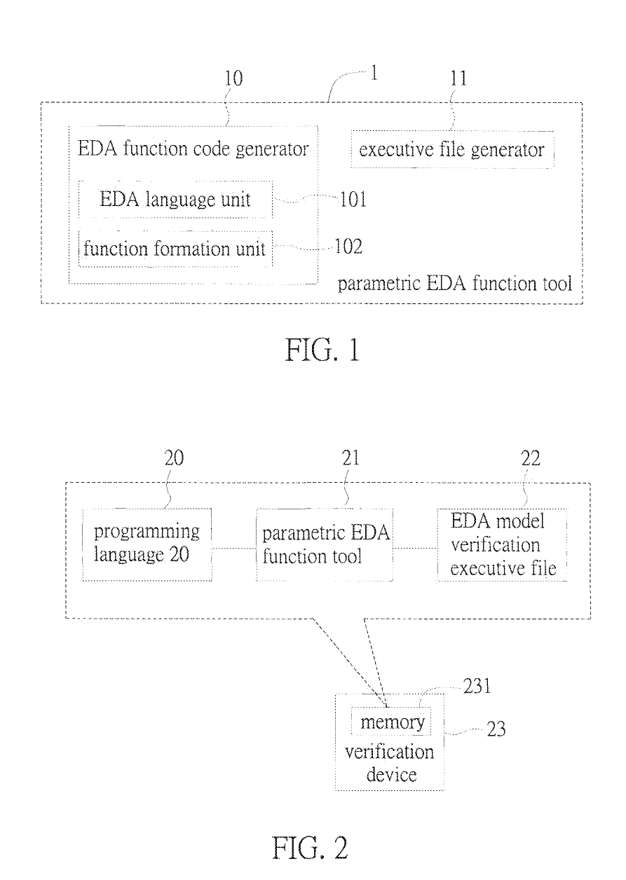

FIG. 1 is a diagram showing a parametric EDA function tool according to the present invention. As shown in the drawing, the parametric EDA function tool 1 comprises an EDA function code generator 10 and an executive file generator 11, wherein the EDA function code generator 10 further comprises an EDA language unit 101 and a function formation unit 102.

The EDA function code generator 10 is used for converting programming language into EDA function codes. In order to facilitate the development and maintenance of symbolic verification applications, the EDA function code generator 10 converts the EDA programming language into EDA function codes, thereby building up simplified program contents.

The EDA language unit 101 is used for converting the programming language into a parametric EDA language mode having format strings and variable length arguments. The EDA language unit 101 uses the concept of printf( ) in C language to create a flexible and parametric programming interface. By setting and converting the programming language through format strings and variable length arguments, a parametric EDA language mode is formed to simplify programming codes.

In a preferred embodiment, the EDA language unit 101 is applied to a programming interface for variable declaration, temporal logic formula declaration and game role declaration.

In another preferred embodiment, the EDA language unit 101 is used for designing a declaration program of a mode, a state, a control point or a rule of a state transition system.

The function formation unit 102 is used for forming EDA function codes from the parametric EDA language so as to facilitate subsequent compiling.

The executive file generator 11 is used for compiling the EDA function codes into an executive file, which is then executed by a verification device, wherein the executive file generator 11 may be an assembler, a compiler and/or an interpreter. The verification device may be a software/hardware test case generator, a software/hardware test scheme generator, a software/hardware model checker or a software/hardware simulator.

In practice, the EDA language unit 101 converts the programming language into a parametric EDA language mode having format strings and variable length arguments; then, the function formation unit 102 forms EDA function codes from the parametric EDA language; and finally, the executive file generator 11 compiles the EDA function codes into an executive file. For example, supposed a parameter i and variables m, x0, x1, . . . , xi, for a condition [symbol] _{jε[1,i]}(m=j [symbol] 0≦xj≦j), since each basic logic atom varies with the value of variable j, it is difficult to express the condition through simplified programming codes by using the traditional library programs. But through the parametric EDA function tool 1 of the present invention, the condition can be expressed using following function codes:

for(j=1;j<=i;j++)
red_declare_variable(“x%d”,j);
c=red_false( );
for(j=1;j<=i;j++){
c=red_or(c,red_diagram(
“m=%d&&0<=x%d&&x%d<=%1d”, j,j,j,j));
}

In the above codes, firstly, i variables x1, x2, . . . , xi are declared. Then, red_false( ) sends back a logic false conditional expression and stores it in variable c. Subsequently, red_or( ) is executed repeatedly to perform an OR operation between the conditional expression in variable c and the conditional expression of red_diagram( ) and further stores the result of the OR operation in variable c. Therefore, through the parametric EDA function tool 1, simple programming codes that are easy to read and easy to maintain can be formed.

FIG. 2 is an application diagram of the parametric EDA function tool according to the present invention. As shown in the drawing, the whole structure comprises: programming language 20, a parametric EDA function tool 21 of the present invention, an EDA model verification executive file 22, a verification device 23 and a memory 231.

In practice, through the parametric EDA function tool 21, the EDA programming language 20 is converted into an EDA model verification executive file 22, which is stored in the memory 231 of the verification device 23 such that it can be executed by the verification device 23.

In a preferred embodiment, the programming language can be programming codes for establishing an EDA model, an EDA object and/or an EDA operation process.

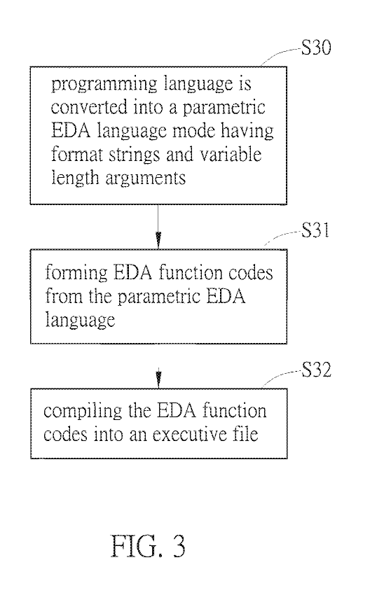

FIG. 3 is a flow diagram showing a method of simplifying the EDA programming language. As shown in the drawing, the method comprises the following steps.

First, at step S30, the programming language is converted into a parametric EDA language mode having format strings and variable length arguments. Then, the process goes to step S31.

At step S31, EDA function codes are formed from the parametric EDA language. Then, the process goes to step S32.

At step S32, the EDA function codes are compiled into an executive file.

In a preferred embodiment, step S32 further comprises: compiling the EDA function codes into an object file, and linking the object file into an executive file by an executive file generator.

In another preferred embodiment, the method of the present invention further comprises the step of loading the executive file by a verification device into a memory thereof and executing the executive file.

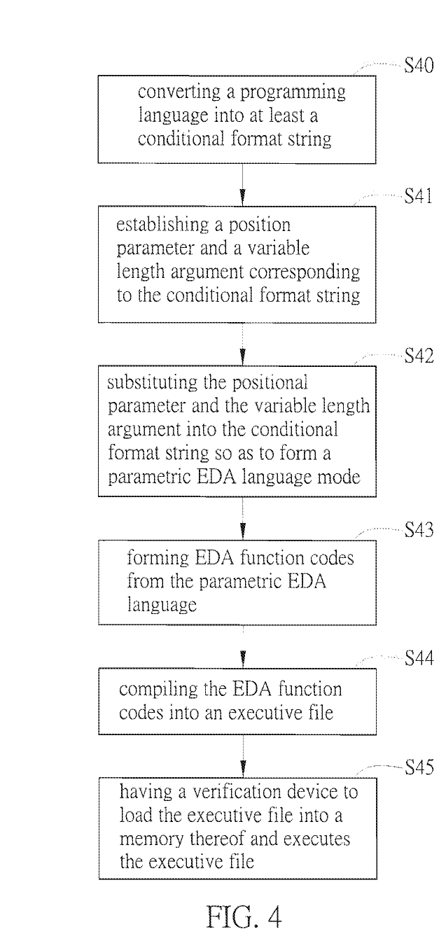

FIG. 4 is a flow diagram showing a method of simplifying the EDA programming language according to a preferred embodiment of the present invention. As shown in the drawing, the method comprises the following steps.

First, at step S40, the programming language is converted into at least a conditional format string. Then, the process goes to step S41.

At step S41, a position parameter and a variable length argument are established corresponding to the conditional format string. Then, the process goes to step S42.

At step S42, the positional parameter and the variable length argument are substituted into the conditional format string so as to form a parametric EDA language mode. Then, the process goes to step S43.

At step S43, EDA function codes are formed from the parametric EDA language. Then, the process goes to step S44.

At step S44, the EDA function codes are compiled into an executive file. Then, the process goes to step S45.

At step S45, a verification device loads the executive file into a memory thereof and executes the executive file.

In a preferred embodiment, in order to declare five variables x1, x2, x3, x4 and x5, the following programming codes are generated according to steps S40 to S42.

for(i=1;i<=5;i++)
red_declare_variable(“x%1d”,i);

wherein red_declare_variable( ) can also accept a variable argument in the style of printf( ).

In another preferred embodiment, the above-described concept can be used to design a declaration program of a mode, a state, a control point or a rule of a state transition system. For example, to declare three system modes ma, mb and mc, wherein the state conditions are x3≦1, x2≦2 and x1≦3, respectively, the following programming codes can be generated. First, the following programming codes are established:

for(i=1;i<=3;i++)
red_declare_mode( );

which represents a conditional format string at step S40.

Then, (“m % c”, “x % 1d<=% 1d”, ‘a’+i−1,4−i,i) is established, which represents a positional parameter and a variable length argument at step S41.

Finally, the above two parts are combined as

for(i=1;i<=3;i++)
red_declare_mode(
“m%c”, “x%1d<=%1d”, `a`+i−1,4−i,i);

which forms a parametric EDA language mode at step S42.

Alternatively, the following programming codes can be established for declaring the three state transition rules.

```
  for(i=1;i<=3;i++)
  red_declare_transition(“x%1d<=%1d”,
“x%1d=0;”,4−i,i,i);
```

wherein the trigger or guard conditions are x3≦1, x2≦2 and x1≦3, and the statements or actions after trigger are “x1=0;”, “x2=0;”, and “x3=0;”, respectively.

Therefore, the present invention builds up a flexible and parametric program interface and converts the programming language into a parametric EDA language mode having format strings and variable length arguments. Accordingly, complicated and huge EDA programming codes in the prior art at converted into symbolic verification application programs that are simple, easy to read and easy to maintain, thereby saving memory spaces occupied by the EDA programming codes, saving the development time, and reducing the development cost and the equipment cost.

Therefore, the parametric EDA function tool and method of simplifying the EDA programming language according to the present invention achieve the following effects:
(1) saving memory spaces occupied by EDA programming codes. When the programming language is converted into a parametric EDA language mode, the EDA programming codes are greatly reduced, thereby saving the memory spaces occupied by the EDA programming codes.
(2) reducing the development cost and equipment cost of manufacturers. Currently, manufacturers in information industries, software verification industries and embedded systems spend a lot of manpower and material resources on the development of EDA softwares. The parametric EDA function tool of the present invention is helpful to reduce the software development and maintenance time and relatively reduce the cost spent on EDA development tools, thereby reducing the development cost and equipment cost of manufacturers.

The above-described descriptions of the detailed embodiments are only to illustrate the preferred implementation according to the present invention, and it is not to limit the scope of the present invention, Accordingly, all modifications and variations completed by those with ordinary skill in the art should fall within the scope of present invention defined by the appended claims.

1. A parametric EDA function tool, comprising:
an EDA function code generator for converting a programming language into EDA function codes; and
I. an executive file generator for compiling the EDA function codes into an executive file to be executed by a verification device,
II. wherein the EDA function code generator comprises:
III. an EDA language unit for converting the programming language into a parametric EDA language mode having format strings and variable length arguments; and
IV. a function formation unit for forming the EDA function codes from the parametric EDA language.

2. The parametric EDA function tool of claim 1, wherein the programming language is programming codes for establishing an EDA model, an EDA object and/or an EDA operation process.

3. The parametric EDA function tool of claim 1, wherein the executive file generator is an assembler, a compiler and/or an interpreter.

4. The parametric EDA function tool of claim 1, wherein the verification device is a software or hardware test case generator.

5. The parametric EDA function tool of claim 1, wherein the verification device is a software or hardware test scheme generator.

6. The parametric EDA function tool of claim 1, wherein the verification device is a software or hardware model checker.

7. The parametric EDA function tool of claim 1, wherein the verification device is a software or hardware simulator.

8. The parametric EDA function tool of claim 1, wherein the EDA language unit establishes a conditional expression through the parametric EDA language.

9. The parametric EDA function tool of claim 8, wherein the EDA language unit converts the programming language into a conditional format string and substitutes a positional parameter and a variable length argument into the conditional format string so as to form a conditional expression of the parametric EDA language mode.

10. The parametric EDA function tool of claim 1, wherein the EDA language unit is applied to a program interface for variable declaration.

11. The parametric EDA function tool of claim 1, wherein the EDA language unit is applied to a program interface for temporal logic formula declaration.

12. The parametric EDA function tool of claim 1, wherein the EDA language unit is applied to a program interface for game role declaration.

13. The parametric EDA function tool of claim 1, wherein the EDA language unit is used to design a declaration program of a mode of a state transition system.

14. The parametric EDA function tool of claim 1, wherein the EDA language unit is used to design a declaration program of a state of a state transition system.

15. The parametric EDA function tool of claim 1, wherein the EDA language unit is used to design a declaration program of a control point of a state transition system.

16. The parametric EDA function tool of claim 1, wherein the EDA language unit is used to design a declaration program of a rule of a state transition system.

17. A method of simplifying EDA programming language, comprising the following steps:
(1) converting the EDA programming language into a parametric EDA language mode having format strings and variable length arguments;
(2) forming EDA function codes from the parametric EDA language; and
(3) compiling the EDA function codes into an executive file.

18. The method of claim 17, wherein step (1) further comprises:
(1-1) converting the EDA programming language into at least a conditional format string;
(1-2) establishing a positional parameter and a variable length argument corresponding to the conditional format string; and
(1-3) substituting the positional parameter and variable length argument into the conditional format string so as to form the parametric EDA language mode.

19. The method of claim 17, wherein step (3) further comprises the following steps:
(3-1) compiling the EDA function codes by an executive file generator into an object file; and
(3-2) linking the object file by the executive file generator into the executive file.

20. The method of claim 19 further comprising step (4) of loading the executive file into a memory of a verification device and executing the executive file.

21. The method of claim 17 further comprising step (4) of loading the executive file into a memory of a verification device and executing the executive file.
